(19) United States
(12) Patent Application Publication
(10) Pub. No.: US 2003/0105745 A1
(43) Pub. Date: Jun. 5, 2003

(54) Text-file based relational database

(76) Inventors: Jason A. Davidson, Forest Grove, OR (US); Shirish Aundhe, Beaverton, OR (US)

Correspondence Address: FISH & RICHARDSON, PC, 4350 LA JOLLA VILLAGE DRIVE, SUITE 500, SAN DIEGO, CA, 92122, US

(21) Appl. No.: 10/008,732

(22) Filed: Dec. 5, 2001

(51) Int. Cl. G06F 7/00

(52) U.S. Cl. 707/3

(57) ABSTRACT

A text-based relational database system is disclosed. Tags specifying data semantics may be used to store data in a text file using a relational database model. An application program interface may be provided that allows the text file data to be accessed as though it were a relational database. A text-based relational database management system may be provided that enables multiple operations on a text-file based relational database. The text file may be an Extensible Markup Language file and the operations may conform to a relational database query protocol standard, such as an Structure Query Language (SQL) standard (e.g., International Standard 9075:1992).

### BACKGROUND

The present application describes systems and techniques relating to relational databases stored as text files using tags to define data semantics, for example, a relational database stored as an Extensible Markup Language (XML) file.

Software applications frequently use some form of data repository or database. In general, a data repository or database is an organized body of related information. During initial development of a software application, software developers may use a simple flat file to store a data repository for testing purposes. A flat file is a collection of records with minimal structure in a format specified at the time the file is designed, such as a comma delimited plain text file.

Many software applications use a larger and more efficient commercially available database. Typically, a database is structured for ease and speed of search and retrieval. One structural component of a conventional database is the database model. Traditional database models include hierarchical, network and relational.

Many modern databases use the relational model. A relational database stores data in tables, which are largely independent of one another. Each table in a relational database is a ‘relation’, which is a two-dimensional array of rows and columns, containing single-valued entries and no duplicate rows. Columns represent attributes of the table and are generally self-consistent. Rows represent records or instances of related data.

A relational database may offer a number of advantages over other database models. One such advantage is structural versatility. Typically, one may change the structure of a particular relational database, such as by adding one or more new columns to a database table, without requiring changes to applications that were based on earlier structures. This is made possible, in part, by the generally declarative nature of the structured query language (SQL) typically used to access a relational database. Typical relational database queries are declarative statements instead of procedural statements because the query identifies only the data needed and specifies nothing about the process by which a database management systems (or database engine) is to collect the data.

Many corporate computer systems have at least one database at their core. In many cases, a complex and versatile database program, which has scalability and includes file locking capabilities, is typically required. Many of the database management systems (DBMS) available today for managing large amounts of data, are very large and sophisticated relational DBMS (RDBMS), which frequently have significant licensing fees.

### DRAWING DESCRIPTIONS

FIG. 1A is a diagram illustrating an example data model for use in storing relational database information in a text file.

FIG. 1B is a diagram illustrating an example relational database structure for storing trading partner information for a company.

FIG. 2A is an example printout of the example relational database structure of FIG. 1B stored as an XML file.

FIG. 2B is an example printout of the example relational database structure of FIG. 1B stored as another XML file.

FIG. 3 is a logic flow diagram of a method of developing a system to store and retrieve information using a data file storing text data, including tags identifying data semantics for a relational database model.

FIG. 4 is a block diagram of a system for accessing data stored in a text file as though the data were stored in a relational database.

FIG. 5 is a logic flow diagram of an example process for querying a relational database stored as plain text in a data file.

FIG. 6 is a block diagram illustrating an example computing environment.

Details of one or more embodiments are set forth in the accompanying drawings and the description below. Other features and advantages may be apparent from the description and drawings, and from the claims.

### DETAILED DESCRIPTION

The systems and techniques described here relate to implementing a relational database as a text file. As used herein, the term “text file” means a data repository stored in a text file format, including data repositories that reside in memory and are never written to a mass storage medium (e.g., magnetic storage disk). Thus, the relational database is text-file based, even if it is not stored in a file on a hard disk.

The present inventors recognized that conventional data repositories used by applications were either not generically applicable or were too complex and/or expensive for many situations. Accordingly, the inventors recognized the potential advantages of providing a “poor man's database” that could be a stand-in or a replacement for a commercially available database system. For example, by providing an SQL style query language for an XML file representing a relational database, database aware applications may be developed and sold without having to pay licensing fees for commercially available database management systems.

Tags specifying data semantics may be used to store data in a text file using a relational database model. An application program interface may be provided that allows the text file data to be accessed as though it were a relational database. A text-based relational database management system may be provided that enables multiple operations on a text-file based relational database. The text file may be an Extensible Markup Language file and the operations may conform to a relational database query protocol standard, such as an Structure Query Language (SQL) standard (e.g., International Standard 9075:1992). Implementations of the text-based relational database systems and techniques may include various combinations of the following features.

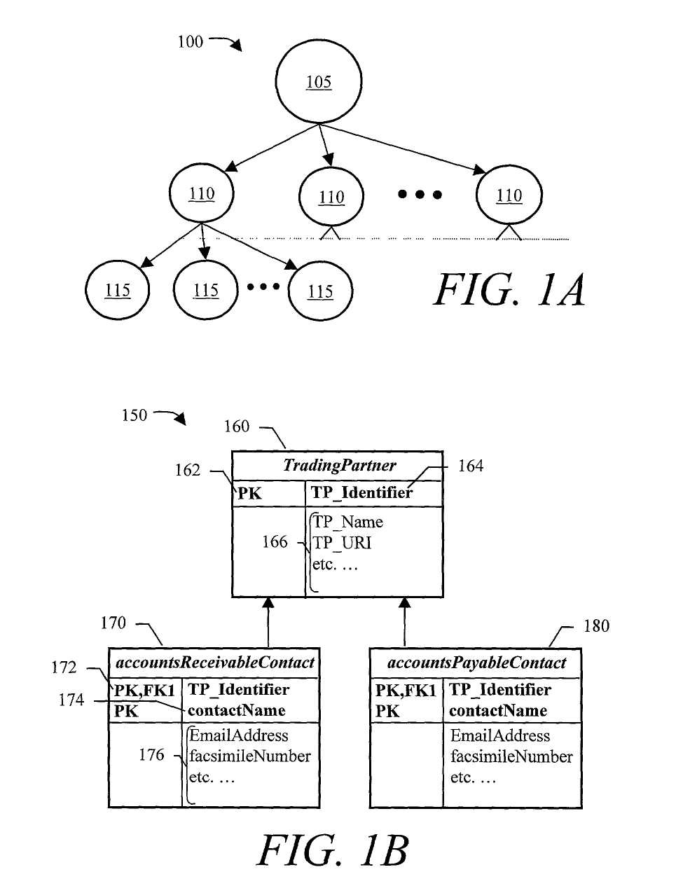

FIG. 1A is a diagram illustrating an example data model for use in storing relational database information in a text file, which can be searched using a database declarative language such as SQL. The data model may be generally regarded as a tree 100. The tree 100 may be stored as a text file that includes tags defining the semantic value of the data. The text data may be plain text, such as ASCII (American Standard Code for Information Interchange) characters.

The tree 100 comprises nodes 105, 110, 115, which may generally be thought of as data elements. The tree 100 includes a root element 105, which may be explicit or implicit. For example, the root element 105 may be explicit, such as when a specific tag identifies the root element 105. Alternatively, the root element 105 may be implicit, such as when it is represented by a declaration at the beginning of the text file, or such as when the text file has an extension on the file's name to identify the type of data contained within.

The root element 105 may have one or more child elements 110, which in turn may have one or more child elements 115, and so on. These elements 110, 115 also may have various associated attributes. An element attribute is information about the element additional to the element name (i.e., the element's tag) and the element content (i.e., the element's data).

The tags that delineate these elements 110, 115 may be implemented using different syntax standards. For example, they may be implemented using XML, which uses beginning and ending tags to surround all element content. Alternatively, they may be implemented using Key/Value pairs to identify elements, along with grouping symbols to group element content, including potentially multiple sub-elements, within a Value field.

FIG. 1B is a diagram illustrating an example relational database structure for storing trading partner information for a company. The relational database structure includes a set of tables 150, which includes a TradingPartner table 160, an accountsReceivableContact table 170 and an accountsPayableContact table 180. The TradingPartner table 160 has a primary key 162, which is a single column/attribute, TP_Identifier 164, representing a unique identifier for each trading partner (e.g., an integer). The TradingPartner table 160 is a parent table, which includes additional columns 166, such as TP_Name (i.e., name of the trading partner), TP_URI (i.e., Universal Resource Identifier for the trading partner).

The accountsReceivableContact table 170 and the accountsPayableContact table 180 are each child tables of the TradingPartner table 160. Thus, for example, the accountsReceivableContact table 170 has a primary key that includes a foreign key component 172, which is the primary key TP_Identifier from the TradingPartner table 160. Additionally, the accountsReceivableContact table 170 has an additional column, contactName 174, serving as a part of its primary key. The accountsReceivableContact table 170 also includes additional columns 176, such as EmailAddress, facsimileNumber, and the like.

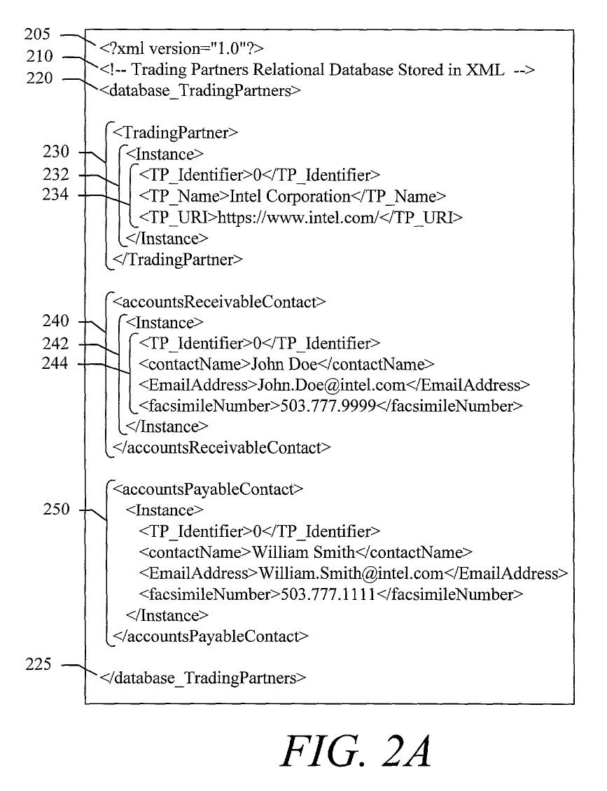

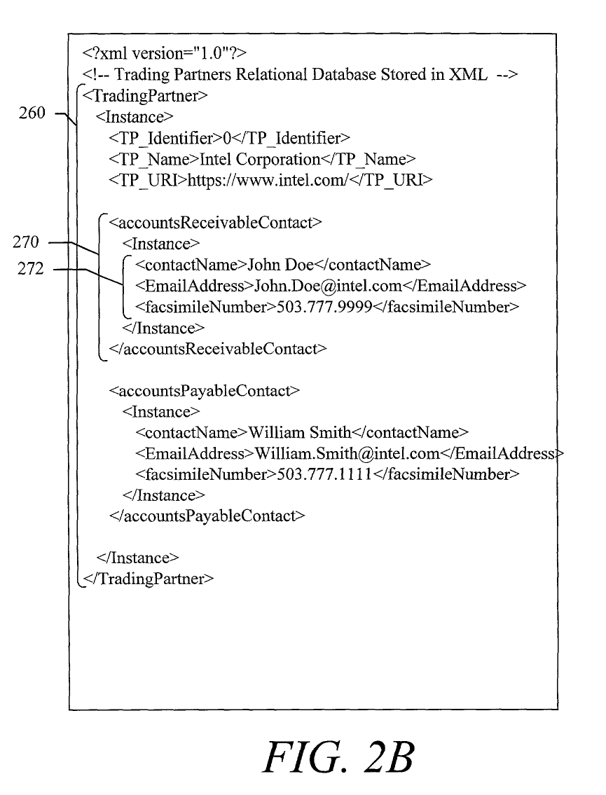

FIG. 2A is an example printout of the example relational database structure of FIG. 1B stored as an XML file. The XML file begins with a declaration 205, which defines the XML version of the document. Following this is a comment 210 noting that the XML file contains a trading partners relational database stored in XML. The next line defines the beginning of a root element for the XML file with a data tag <database_TradingPartner> 220, and the last line defines the end of the root element with the a data tag </database_TradingPartner> 225.

The TradingPartner table is stored in the XML file as a TradingPartner element 230. Every row of the TradingPartner table is stored as an instance element, such as a first instance element 232, in the TradingPartner element 230. Within each instance element of the TradingPartner element 230 are column elements 234, which store data values for the TradingPartner table. A primary key for the TradingPartner table may be identified by a data tag, or the primary key may be defined in the software that manages the plain text relational database.

The accountsReceivableContact (ARC) table is a child table of the TradingPartner table, and the ARC table is stored as an ARC element 240. Every row of the ARC table is stored as an instance element, such as a first instance element 242, in the ARC element 240. Within each instance element of the ARC element 240 are column elements 244, which store data values for the ARC table.

As before, a primary key for the ARC table may be identified by a data tag, or the primary key may be defined in the software that manages the plain text relational database. In the example presented, the primary key for the ARC table is a compound primary key having a foreign key, TP_Identifier, and a local key, contactName.

The accountsPayableContact (APC) table is also a child table of the TradingPartner table, and the APC table is stored as an APC element 250. The APC element 250 has sub-elements similar to the ARC element 240.

In this example plain text relational database, the column elements are defined by tags that have the same names as the table attributes. However, the tags used to identify columns within each instance may also be generic, such as <column1>data</column1>, <column2>data</column2>, <column3>data</column3>, and a correlation between the columns for each table and the attribute names for each table may be defined elsewhere in the plain text relational database. Moreover, all the tags used may be generic, and various names for the database may be defined in a metadata section (i.e., a database schema section) of the plain text relational database.

In addition, parent-child relationships for the relational database may be stored using the parent-child relationships of elements in the plain text. FIG. 2B is an example printout of the example relational database structure of FIG. 1B stored as another XML file.

In FIG. 2B, the TradingPartner table is stored as a root element 260. A portion of the ARC table is stored as an ARC element 270 within an instance element of the root element 260. Column elements 272 no longer include the foreign key, TP_Identifier, because only those portions of the ARC table that have this foreign key are stored within the corresponding instance element of the root element 260.

The relational database structure of FIG. 1B and the corresponding XML files of FIGS. 2A and 2B are presented by way of example only. Different applications of the systems and techniques described may utilize different relational database structures. Moreover, many alternative data models for use in storing relational database information in plain text using tags defining data semantics are possible.

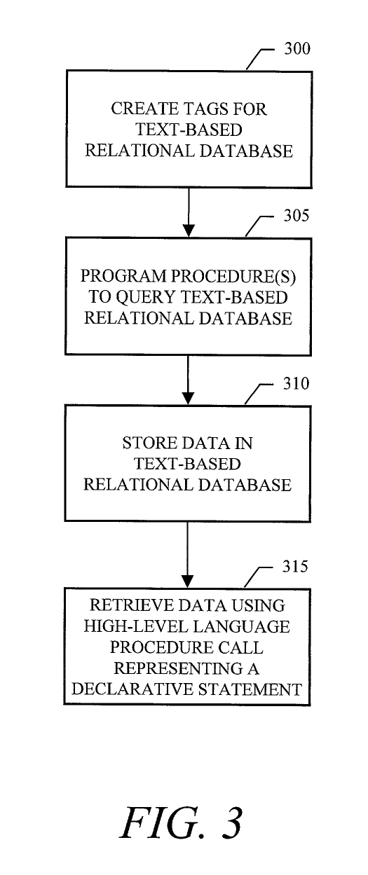

FIG. 3 is a logic flow diagram of a method of developing a system to store and retrieve information using a data file storing text data, including tags identifying data semantics for a relational database model. The method begins at 300, in which a software developer creates tags for a text-based relational database. As discussed above, these tags may be generic or may be specific to the data to be stored. For example, a software developer may generate tags that clearly identify tables and attributes applicable to a particular problem space.

Then at 305, the software developer programs one or more procedures to query the text-based relational database. The number of procedures programmed at 305 depends on the application and design goals. For example, a software developer may enter data directly into the text-based relational database using a text editor, and then program a single query procedure. Alternatively, a software developer may program one or more procedures to perform multiple standard relational database operations, such as Select, Update, Add, Insert, and Delete.

In the latter case, the procedures programmed in 305 may constitute a full RDBMS for storing, retrieving and modifying information in a text-based relational database. Moreover, this text-based relational database management system (TB-RDBMS) may comply with a recognized standard, such as American National Standard X3.135-1992 (International Standard 9075:1992), which codifies the relational database language standards for SQL. A TB-RDBMS may also comply with only a specified implementation subset of SQL, such as Entry SQL-92 or Intermediate SQL-92.

Moreover, a TB-RDBMS may be designed to implement additional aspects of a relational database, including attribute domains and constraints, database views, catalogs and clusters. The TB-RDBMS may maintain entity integrity, domain integrity and referential integrity in a text-based relational database. The TB-RDBMS may maintain a text-based relational database in a number of different normal forms, including first normal form, second normal form, third normal form, fourth normal form, fifth normal form, Boyce-Codd normal form (BCNF), and domain/key normal form (DKNF). The TB-RDBMS may have portions that reside in both a server and a client in a client-server environment, such as the World Wide Web. The functionality of the TB-RDBMS may be exposed through additional standard interfaces, such as ODBC (Open Database Connectivity) and JDBC (Java Database Connection).

Following 305, data is stored in the text-based relational database at 310. As described above, data may be stored in the text-based relational database using a text editor Alternatively, data may be stored in the text-based relational database using a TB-RDBMS.

Then at 315, data is retrieved from the text-based relational database using a high-level language procedure call representing a declarative statement. The declarative statement includes an operation (e.g., Select in SQL), attribute(s) specification (including multiple attributes specification, such as with a wild card operator (e.g, *)), a table specification, and one or more conditionals.

For example, an SQL statement such as

‘Select EmailAddress From accountsReceivableContact Where contactName=“John Doe”’

may become a Java class procedure call such as,

‘QueryNodeValue(“EmailAddress”, “accountsReceivableContact”, “contactName”, “John Doe”);’

Alternatively, this SQL statement may become a procedure call such as,

‘PerformOperation(“Select”, “EmailAddress”, “accountsReceivableContact”, “contactName”, “John Doe”);’

or,

‘PerformOperation(“Select EmailAddress From accountsReceivableContact Where contactName=‘John Doe’”);’.

Many alternatives formats are possible, depending upon the plain text relational database structure and design goals.

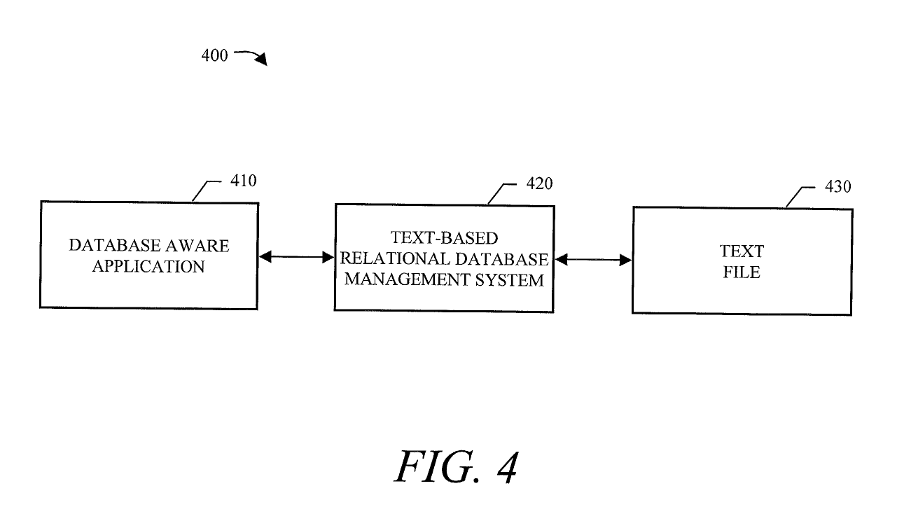

FIG. 4 is a block diagram of a system 400 for accessing data stored in a text file as though the data were stored in a relational database. The system 400 includes a database (DB) aware application 410. The DB aware application 410 uses information stored in a text file 430 and stores additional information in the text file 430 during operation. The DB aware application 410 may use procedure calls conforming to a recognized standard for accessing a relational database. For example, the procedure calls may reflect conventional SQL statements.

A TB-RDBMS 420 provides an application program interface that allows the procedure calls to operate on the text file 430. The TB-RDBMS 420 may include multiple levels of functionality as described above. The TB-RDBMS 420 may be built using other existing technologies for accessing text files. For example, in the case of an XML-based text file, the TB-RDBMS 420 may use available technologies for accessing transmitted XML data, such as DOM (Document Object Model), XPATH, XML Query and/or XQL (XML Query Language).

By using a standardized public interface for relational database procedure calls, the TB-RDBMS 420 may be used as a software development tool. For example, the text file 430 may be used as a repository of sample data during the development of the DB aware application 410. This repository can then be accessed in a normal database fashion (i.e., using SQL statements) during development of the DB aware application 410 without having to pay licensing fees for a commercially available DBMS. If a commercially available DBMS is later needed or desired, the DB aware application 410 may then be smoothly transitioned to this type of DBMS, since the public interface for the TB-RDBMS 420 conforms to a recognized standard.

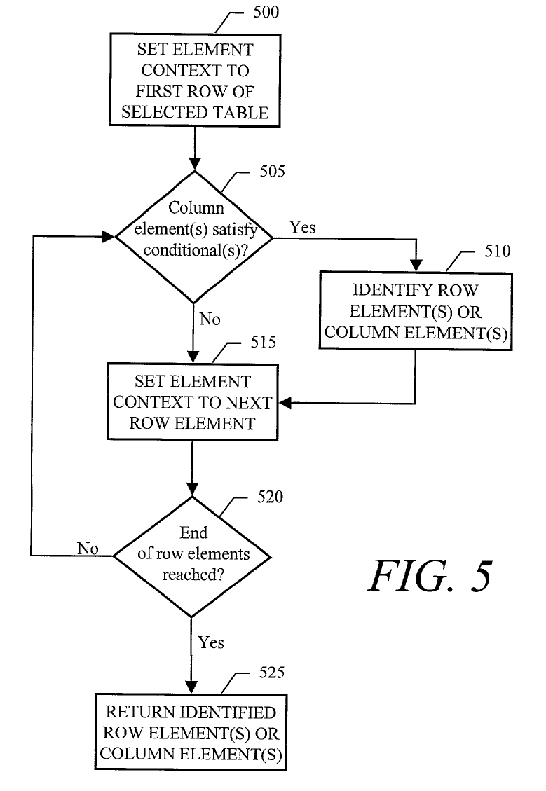

FIG. 5 is a logic flow diagram of an example process for querying a relational database stored as plain text in a data file. In the example of FIG. 5, the relational database is stored as an XML file in plain text, and the TB-RDBMS implements an SQL Select operation. The process begin at 500, in which an element context is set to a first row element of a selected table element. For example, an XPATH operation ‘xpath.selectSingleNode’ may be called.

Following this, a check is made at 505 to determine if one or more column elements satisfy one or more specified conditionals. If so control passes to 510. Otherwise control passes to 515.

At 510, a desired return value is identified. Potential desired return values include row element(s), column element(s), or just the values of these. The identification at 510 may involve making a copy of data, storing an index value, storing a memory pointer, etc.

Following 510, the element context is set to the next row element at 515. Then at 520, a check is made to determine if no additional row elements remain for the selected table element. If not, control passes back to 505. If so, control passes to 525, in which the identified return value or values are returned.

FIG. 5 represents a standard query command, where the table and the conditional(s) are specified by the command. Additional relational database operations may be implemented as described above in a similar fashion.

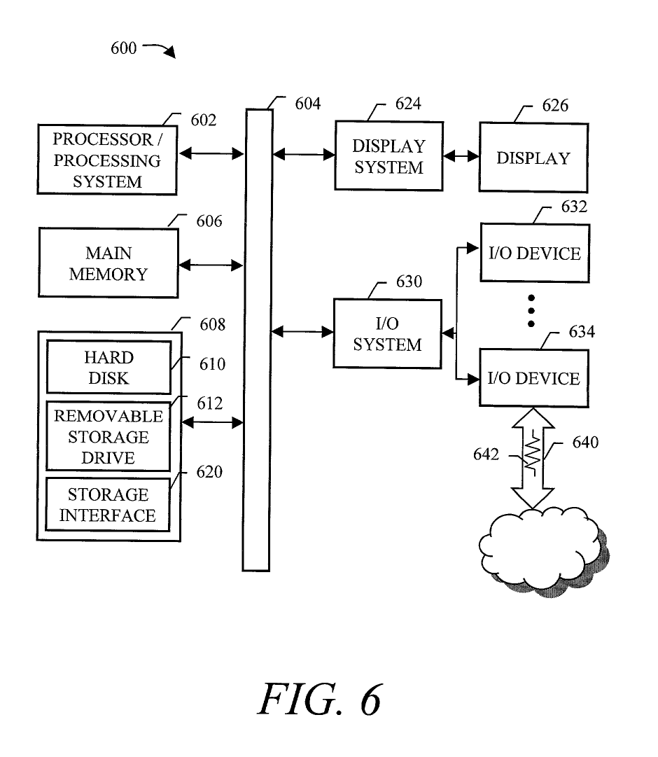

FIG. 6 is a block diagram illustrating an example computing environment. An example machine 600 includes a processing system 602, which may include a central processing unit such as a microprocessor or microcontroller for executing programs to control tasks in the machine 600, thereby enabling the features and function described above. Moreover, the processing system 602 may include one or more additional processors, which may be discrete processors or may be built into the central processing unit.

The processing system 602 is coupled with a bus 604, which provides a set of signals for communicating with the processing system 602 and may include a data channel for facilitating information transfer between storage and other peripheral components of the machine 600.

The machine 600 may include embedded controllers, such as Generic or Programmable Logic Devices or Arrays (PLD, PLA, GAL, PAL), Field Programmable Gate Arrays (FPGA), Application Specific Integrated Circuits (ASIC), single-chip computers, smart cards, or the like, which may serve as the processing system 602.

The machine 600 may include a main memory 606 and one or more cache memories, and may also include a secondary memory 608. These memories provide storage of instructions and data for programs executing on the processing system 602, and may be semiconductor based and/or non-semiconductor based memory. The secondary memory 608 may include, for example, a hard disk drive 610, a removable storage drive 612 and/or a storage interface 620.

The machine 600 may also include a display system 624 for connecting to a display device 626. The machine 600 includes an input/output (I/O) system 630 (i.e., one or more controllers or adapters for providing interface functions) for connecting to one or more I/O devices 632-634. The I/O system 630 may provide a communications interface, which allows software and data to be transferred, in the form of signals 642, between machine 600 and external devices, networks or information sources. The signals 642 may be any signals (e.g., electronic, electromagnetic, optical, etc.) capable of being received via a channel 640 (e.g., wire, cable, optical fiber, phone line, infrared (IR) channel, radio frequency (RF) channel, etc.). A communications interface used to receive these signals 642 may be a network interface card designed for a particular type of network, protocol and channel medium, or may be designed to serve multiple networks, protocols and/or channel media.

Machine instructions (also known as programs, software or code) may be stored in the machine 600 or delivered to the machine 600 over a communications interface. As used herein, the term “machine-readable medium” refers to any media used to provide information indicative of one or more operational instructions for the machine 600. Such information includes machine instructions provided to the processing system 602 for execution, and such media include embedded controllers, memory devices/units, and signals on a channel.

Other systems, architectures, and modifications and/or reconfigurations of machine 600 of FIG. 6 are also possible. The various implementations described above have been presented by way of example only, and not limitation. For example, the logic flows depicted in FIGS. 3 and 5 do not require the particular order shown, or that the steps be performed in sequential order. In certain implementations, multi-tasking and parallel processing may be preferable. Thus, other embodiments may be within the scope of the following claims.

What is claimed is:

1. A method comprising:
designating tags that specify data semantics to be used in storing information in a text file using a relational database model; and
creating a programming interface that enables access to the text file as a relational database, the programming interface including a procedure call format representing a declarative statement.

2. The method of claim 1, wherein the tags comprise data domain generic tags.

3. The method of claim 1, wherein the tags comprise data domain specific tags.

4. The method of claim 3, wherein the procedure call format specifies a plurality of inputs of a character string type for a procedure.

5. The method of claim 4, wherein the inputs comprise a subset of the tags, and output data from the procedure does not include the tags.

6. The method of claim 1, wherein the procedure call format supports one or more relational database operations, which include a select operation, an update operation, an add operation, an insert operation, and a delete operation.

7. The method of claim 6, wherein the represented declarative statement corresponds to a relational database query protocol standard.

8. The method of claim 7, wherein the text file comprises plain text in American Standard Code for Information Interchange format.

9. The method of claim 8, wherein the plain text conforms to version 1.0 of Extensible Markup Language.

10. The method of claim 9, wherein the relational database query protocol standard is International Standard 9075:1992.

11. A machine-implemented method comprising:
managing a text file as a relational database, the text file comprising tags specifying data semantics; and
providing an application program interface including a procedure call for accessing the relational database.

12. The method of claim 11, wherein the tags comprise data domain specific tags.

13. The method of claim 11, wherein the procedure call comprises a high-level language procedure call having a procedure call format representing a declarative statement.

14. The method of claim 13, wherein the procedure call format specifies a plurality of inputs of a character string type for a procedure.

15. The method of claim 14, wherein the inputs comprise a subset of the tags, and output data from the procedure does not include the tags.

16. The method of claim 11, wherein the procedure call supports one or more relational database operations, which include a select operation, an update operation, an add operation, an insert operation, and a delete operation.

17. The method of claim 16, wherein the procedure call has a format corresponding to a relational database query protocol standard.

18. The method of claim 17, wherein the text file comprises plain text in American Standard Code for Information Interchange format.

19. The method of claim 18, wherein the plain text conforms to version 1.0 of Extensible Markup Language.

20. The method of claim 19, wherein the relational database query protocol standard is International Standard 9075:1992.

21. A machine-readable medium embodying information indicative of instructions for causing one or more machines to perform operations comprising:
making information stored in a text file comprising tags specifying data semantics corresponding to a relational database model available through a procedure call interface;
receiving from an application a relational database request using the procedure call interface; and
returning data from the text file corresponding to the relational database request.

22. The machine-readable medium of claim 21, wherein the procedure call interface comprises a high-level language procedure call having a procedure call format representing a declarative statement.

23. The machine-readable medium of claim 21, wherein the procedure call interface supports one or more relational database operations, which include a select operation, an update operation, an add operation, an insert operation, and a delete operation.

24. The machine-readable medium of claim 21, wherein the procedure call has a format corresponding to a relational database query protocol standard.

25. The machine-readable medium of claim 24, wherein the text file comprises plain text in American Standard Code for Information Interchange format, and wherein the plain text conforms to version 1.0 of Extensible Markup Language.

26. The machine-readable medium of claim 24, wherein the relational database query protocol standard is International Standard 9075:1992.

27. A system comprising:
a text file to store data using tags specifying data semantics corresponding to a relational database model; and
an application program interface that enables a database aware application to access data stored in the text file using one or more relational database operations including a select operation, an update operation, an add operation, an insert operation, and a delete operation.

28. The system of claim 27, wherein the one or more relational database operations conform to a relational database query protocol standard, and wherein the text file conforms to version 1.0 of Extensible Markup Language.

29. A system comprising:
means for storing data in a text file using tags specifying data semantics corresponding to a relational database model; and
means for enabling a database aware application to access data stored in the text file using one or more relational database operations including a select operation, an update operation, an add operation, an insert operation, and a delete operation.

30. The system of claim 29, wherein the one or more relational database operations conform to a relational database query protocol standard, and wherein the text file conforms to version 1.0 of Extensible Markup Language.
